(19) United States
(12) Patent Application Publication
(10) Pub. No.: US 2013/0203825 A1
(43) Pub. Date: Aug. 8, 2013

(54) PHOSPHATE-FREE HIGHLY CONCENTRATED AQUEOUS DISPERSION COMPOSITION OF BIOCIDES AND PROCESS FOR PREPARING THE SAME

(71) Applicants: Raman Premachandran, Saddle Brook, NJ (US); Karen Winkowski, Springfield, NJ (US)

(72) Inventors: Raman Premachandran, Saddle Brook, NJ (US); Karen Winkowski, Springfield, NJ (US)

(73) Assignee: ISP Investments Inc., Wilmington, DE (US)

(21) Appl. No.: 13/700,552

(22) PCT Filed: May 26, 2011
(86) PCT No.: PCT/US11/38164

§ 371 Date: Jan. 23, 2013

Related U.S. Application Data
(60) Provisional application No. 61/349,276, filed on May 28, 2010.

(51) Int. Cl. A01N 25/04; A01N 47/12; A01N 43/80

(52) U.S. Cl. CPC A01N 25/04; A01N 43/80; A01N 47/12
USPC 514/373; 514/372

(57) ABSTRACT

A phosphate-free, highly-concentrated aqueous dispersion composition comprising at least one biocide, sulfosuccinate based surfactant, block copolymer, suspending agent, and optionally an antifoaming agent and desired additives if any. The composition of the present application is significantly stable against heat, cold, transit, storage and dilution for at least 18 months. The preferred biocides of the dispersion composition are 2-meth-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (Off) 3-Iodo-2-propynylbutyl carbamate (IPBC), oxyfluorfen, thiabendazole, terbutryn, zinc pyrithione (ZnPy), bronopol, folpet, diiiron, dehydroacetic acid (DHA), dazomet and carbendazim alone or in combination. Also disclosed is a process for preparing the dispersion composition and appropriate applications thereof.

### FIELD OF THE INVENTION

This application relates to a phosphate-free highly concentrated aqueous dispersion composition comprising at least one biocidal compound and a process for preparing the same.

### BACKGROUND OF THE INVENTION

There is an increasing demand for phosphate-free, aqueous-based biocide compositions because of various regulatory limitations raised by different governmental organizations of developed and developing countries to render eco-friendly products to the society. Mostly, effective biocides or antimicrobial agents are substantially water insoluble or hydrolysis-sensitive, so, alternative approaches have been explored by the artisans to formulate and deliver these compositions. For this reason, various delivery systems and compositions have been proposed to provide aqueous based dispersions of substantially water-insoluble biocide active chemicals such as 2-methyl-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (OIT), 3-Iodo-2-propynylbutyl carbamate (IPBC), etc. Unfortunately, many of these compositions reported to have a presence of phosphate based constituents to provide better compositions.

Also, the drive for “low-VOC” (volatile organic constituents) or “no-VOC” formulations has evoked interest in the domain of aqueous based biocide compositions for numerous end user applications. As a result, many industries have attempted to develop purely aqueous based biocide compositions, but unfortunately these compositions had a threat of microbial attack. To accomplish the demand, inventors have developed several forms of high concentrated biocide compositions which are overwhelmingly supported by related industries due to their reduced transport cost and storage space. Unluckily, the process for preparing high concentrated aqueous biocide dispersion with very low water content can lead to various instabilities on long term storage if appropriate care is not paid. The instabilities include (a) high viscosity and low dispersibility due to aggregation with time; (b) dehydration of the composition on storage due to swelling of the ingredients present in the formulations or slow evaporation of water; and (c) improper dispersibility of diluted solutions of concentrated compositions leading to fast settling.

Concentrated biocide compositions are difficult to prepare in stable and pumpable form due to their rapid aggregation and high viscosity. For example, the formulations described in US Publication No. 20070224135A1 which consist of more than 25 wt % of a biocide were of high viscosity and not pumpable.

U.S. Pat. No. 6,306,413 assigned to Zeneca Limited discloses a stable aqueous formulation comprising from 5 to 30% by weight of a microbiologically active agent containing at least 50% BIT, from 1 to 4% dispersant and from 0.1 to 0.5% by weight Xanthan gum, which formulation is substantially free from organic solvents.

PCT Publication No. WO2009121061 discloses a process of making a stable aqueous dispersion of concentrated, finely divided particles of a biocide active, and compositions thereof by grinding the selected biocide in water in the presence of a non-ionic polymeric dispersant and optionally a co-dispersant.

US Patent Publication No. 20080274154 discloses about highly concentrated, water-based dispersions of certain lipophilic and/or hydrophobic antimicrobially active materials stabilized by a surfactant combination including a nonionic acrylic graft copolymer surfactant and an alkoxylated polyarylphenol phosphate ester surfactant.

In view of the above, there remains a need to discover a highly concentrated aqueous based dispersion composition for biocides or antimicrobial agents which is storage-stable, heat and cold stable, transit-stable, dilution stable, phosphate-free, easily flowable and pumpable to a container.

### SUMMARY OF THE INVENTION

The present application provides a phosphate-free highly concentrated aqueous biocide dispersion composition comprising at least one biocide compound, sulfosuccinate surfactant, block copolymer, suspending agent and optionally an antifoaming agent.

The phosphate-free highly concentrated aqueous biocide dispersion composition of the present application is transport-pro, cost-effective, effectively dispersible, non-dryable on storage and free from settling on dilution.

In a preferred embodiment, the application is a dispersion composition which comprises about 5 to about 50 mass percent of a selected antimicrobial agents.

An objective of the present application is to provide a heat and cold stable aqueous biocide dispersion composition which is stable for at least 18 months at room temperature or stable for at least 5 freeze/thaw cycles wherein temperature is cycled from 50° C. to −24° C. every 24 hours, or stable for at least 4 weeks at about 50° C.

Another objective of the present application is to provide a flowable aqueous biocide dispersion composition to be able to transport by gravity, conventional mechanical or by pneumatic pumping means.

Yet another objective of the present application is to provide a phosphate-free highly concentrated aqueous biocide dispersion composition wherein the biocide is selected from the group consisting of insecticides, acaricides, algicides, molluscicides, bactericides, herbicides, plant growth regulators and/or fungicides.

In accordance with one preferred aspect of the present application, there is provided a process for preparing a stable, flowable and phosphate-free highly concentrated aqueous dispersion composition of biocide comprising the steps of: (i) preparing a homogenous mixture of at least one biocide, sulfosuccinate surfactant, block copolymer, suspending agent and additives if any by thoroughly mixing them for at least 15 minutes; (ii) grinding the resultant homogenous mixture (i) with a grinding aid such as zirconium dioxide beads until it results in a Hegmann number of about 6 to 7; and (iii) optionally, adding an antifoaming agent.

Yet another embodiment of the present application is to employ suitable additives for preparing the desired aqueous biocide dispersion composition is selected from the group comprising wetting agents, thickening agents, dispersing agents, inert carriers, metal oxides, pH modifiers, amines, preservatives, anti-microbial agents alone or in combination. The inert carrier for aqueous dispersion composition is selected from the group comprising ground natural minerals, ground synthetic minerals and/or metal oxides.

In accordance with further objective of the present application, the aqueous biocide dispersion composition prepared according to the above said process is employed in the field of paint, building materials, stucco, concrete, caulks, sealants, joint compounds, adhesives, leather, wood, inks, pigment dispersions, metal working fluids, drilling mud, house hold, cleaning, detergent, agriculture, seed coatings, pesticide and/or clay slurries.

### DESCRIPTION OF THE INVENTION

While this specification concludes with claims particularly pointing out and distinctly claiming that which is regarded as the invention, it is anticipated that the invention can be more readily understood through reading the following detailed description of the application and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of and “consisting essentially of which can be used to characterize the essential ingredients, water, biocide, block-copolymer, sulfosuccinate surfactant, and suspending agent of the present aqueous biocide dispersion compositions.

All percentages, parts, proportions and ratios as used herein, are by weight of the total composition, unless otherwise specified. All such weights as they pertain to listed ingredients are based on the active level and, therefore do not include solvents or by-products that may be included in commercially available materials, unless otherwise specified.

All references to singular characteristics or limitations of the present application shall include the corresponding plural characteristic or limitation, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

The term “about” can indicate a variation of 10 percent of the value specified; for example about 50 percent carries a variation from 45 to 55 percent. For integer ranges, the term about can include one or two integers greater than and less than a recited integer.

The patents and publications referred to herein are hereby incorporated by reference in their entirety.

The term “biocide” or “antimicrobial” as used herein is to be understood to refer to agents such as germicides, bactericides, fungicides, algicides, aquaticides, herbicides, insecticides, larvicides, pesticides, rodenticides, taeniacides, plant growth regulators and the like, which are used for their ability to inhibit growth of and/or destroy biological and/or microbiological species such as bacteria, fungi, algae, caterpillar, insects, larvae, mildew, rodents, spider, worm and the like.

As used herein the term “phosphate-free” means that the aqueous biocide dispersion composition does not include phosphate-containing materials, for example, alkali-metal salts of phosphates, phosphate esters, phosphate acids, alkyl phosphates, alkenyl phosphates, hydroxyalkyl phosphates, polyoxyalkylene alkyl ether phosphates, salts thereof, polyoxyalkylene alkenyl ether phosphates, salts thereof, polyoxyalkylene hydroxyalkyl ether phosphates and salts thereof.

In a particular embodiment of the present application, the suitable biocide employed to prepare the phosphate-free highly concentrated aqueous biocide dispersion composition would include, but not limited to, 3-allyloxy-1,2-benzoisothiazol-1,1-dioxide; basic copper chloride; basic copper sulfate; 1,2-benzisothiazoline-3-one (BIT); 2-methyl-4-isothiazoline-3-one (MIT); 5-chloro-2-methyl-4-isothiazolin-3-one (CMIT); 2-octyl-4-isothiazolin-3-one (OIT); 3-iodo-2-propynylbutyl carbamate (IPBC); oxyfluorfen; thiabendazole; terbutryn; zinc pyrithione (ZnPy); bronopol; folpet; diuron; dehydroacetic acid (DHA); dazomet; carbendazim; methyl-N-(1H-benzoimidazol-2-yl) carbamate; 2-(tert-butylamino)-4-(cyclopropylamino)-6-(methylthio)-s-triazine; 2-tert-butylamino-4-ethylamino-6-methylmercapto-s-triazine; S—N-butyl-5′-para-tert-butylbenzyl-N-3-pyridyldithiocarbonylimidate; 2-chloro-1-(3-ethoxy-4-nitrophenoxy)-4-(trifluromethyl)benzene; 4-chlorophenoxy-3,3 -dimethyl-1-(1H-1,1,3,4-triazol-1-yl)-2-butanone; α-[2-(4-chlorophenyl)ethyl]-α-(1,1-dimethylethyl)-1H-1,2,4-triazole-1-ethanol; copper 8-quinolinate; cycloheximide; bis-(dimethyldithiocarbamoyl)disulfide; 11-dehydrodibenzo(b,f)azepine; 2,4-dichloro-6-(0-chloroanilino)-1,3,5-triazine; 1,4-dichloro-2,5-dimethoxybenzene; N′-dichlorofluoromethylthio-N,N-dimethyl-N-phenyl sulfamide; 2,3-dichlom-1,4-naphthoquinone; 2,6-dichloro-4-nitroaniline; 4,5-dichloro-2-N-octyl-4-isothiazolin-3-one; N-(3,5-dichlorophenyl)-1,2-dimethylcyclopropane-1,2-dicarboxyimide; N′-(3,4-dichlorophenyl)-N,N-dimethylurea; 1-[2-(2,4-dichlorophenyl)-4-ethyl-1,3-dioxorane-2-ylmethyl]-1H,1,2,4-triazol; N-(3,5-dichlorophenyl)succinamide; 1-[[2(2,4-dichlorophenyl)-4-propyl-1,3-dioxolan-2-yl]methyl]1-H-1,2,4-triazole; N-2,3-dichlorophenyltetrachlorophthalamic acid; 3-(3,5-dichlorophenyl)5-ethenyl5-methyloxazolizine-2,4-dione; 2,3-dieyano-1,4-dithioanthraquinone; N-(2,6-diethylphenyl)-4-methylphthalimide; N-(2,6-p-diethylphenyl)phthalimide; 5,6-dihydro-2-methyl-1,4-oxathine-3-carboxanilide; 5,6-dihydro-2-methyl-1,4-oxathine-3-carboxanilido-4,4-dioxide; diisopropyl 1,3-dithiolane-2-iridene malonate; N,N-diisopropyl S-benzylphosphorothioate; 2-dimethylamino-4-methyl-5-N-butyl-6-hydroxypyrimidine; diethyl 2-dimethoxyphosphinothioylsulfanylbutanedioate; bis-(dimethyldithiocarbamoyl)ethylenediamine; 5-ethoxy-3-trichloromethyl-1,2,4-thiaziazole; ethyl-N-(3-dimethylaminopropyl)thiocarbamate hydrochloride; O-ethyl S,S-diphenyldithiophosphate; 3,3′-ethylene-bis-(tetrahydro-4,6-dimethyl-2H-1,3,5-thiadiazine-2-thione); 3-hydroxy-5-methylisooxazole; 3-iodo-2-propargyl butyl carbamate;, iron methanearsonate; 3′-isopropoxy-2-methylbenzanilide; 1-isopropylcarbamoyl-3-(3,5-dichlorophenyl)hydantoin; kasugamycin; manganese ethylene-bis-(dithiocarbamate); 1,2-bis-(3-methoxycarbon yl-2-thioureido)benzene; methyl-1(butylcarbamoyl)-2-benzimidazolecarbamate; 5-methyl-10-butoxycarbonylamino-10; 3-methyl-4-chlorobenzthiazol-2-one; methyl-D,L-N-(2,6-dimethylphenyl)-N-(2′-methoxyacetyl)-alaninate; S,S-6-methylquinoxaline-2,3-di-yldithiocarbonate 5 -methyl-s-triazol-(3,4-b)benzthiazole; nickel dimethyldithioearbamate; 2-octyl-2H-isothiazol-3-one; 2-oxy-3-chloro-1,4-naphthoquinone copper sulfate; pentachloronitrobenzene; (3-phenoxyphenyl)methyl(+/−)-cis,trans-3-(2,2-dichloroethenyl)-2,2-dimethylcyclopropane carboxylate; polyoxine; potassium N-hydroxymethyl-N-methyldithiocarbamate; N-propyl-N-[2-(2,4,6-trichlorophenoxy)ethyl[imidazol-1-carboxamide; 2-pyridinethiol-1-oxide sodium salt; sodium pyrithione; N-tetrachloro-ethylthio-4-cyclohexene-1,2-dicarboxyimide; tetrachloroisophthalonitrile; 4,5,6,7-tetrachlorophthalide; 1,2,5,6-tetrahydro-4H-pyrrolol-[3,2,1-i,j]quinoline-2-one; 2-(thiocyanomethylthio)benzothiazole; N-trichloromethylthio 4-cyclohexene-1,2-dicarboxyimide; silver; copper; N-(trichloromethylthio)phthalimide; validamycin; zinc ethylene-bis-(dithiocarbamate); zinc bis-(1-hydroxy-2(1H)pyridinethionate; and/or zinc propylene-bis-(dithiocarbamate).

The percentage of biocide present in the highly concentrated aqueous dispersion composition of the present application is from about 5.0 wt % to about 50.0 wt % mass percent of any of the above disclosed antimicrobial agents alone or in combination.

Accordingly, it is an aspect of the present application that sulfosuccinate based anionic surfactants are employed for the preparation of phosphate-free aqueous biocide dispersion compositions. The sulfosuccinate type surfactants are mild surfactants amongst all the anionic surfactants and they are similar to alkyl sulfonates. Sulfosuccinate surfactants are of great interest because of their excellent properties such as foaming, strong wetting, emulsifying and solublizing properties, extraordinary surface activity, and effective reduction of surface tension, biodegradability, extreme mildness and low critical micelle concentration (CMC). The suitable sulfosuccinate surfactant is selected from the group consisting of sulfosuccinate monoester, sulfosuccinate diester, monoalkyl sulfosuccinate, dialkyl sulfosuccinate, alkylaryl sulfosuccinate, alkylcycloalkyl sulfosuccinate or their alkali metal salts. The preferred sulfosuccinate surfactants are selected from the group including but are not limited to lauryl sulfosuccinate, laureth sulfosuccinate, laureth-5 sulfosuccinate, ricinoleamide MEA sulfosuccinate, undecylenearnide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts alone or in combination. The commercially available sulfosuccinate based surface active agents would include, but are not limited to, AEROSOL OT, AEROSOL EF800, AEROSOL MA80, AEROSOL OT 100, AEROSOL IB-45, MACKANATE DC-50, SOLE TERGE-8, AEROSOL 18, AEROSOL 22, AEROSOL A102, AEROSOL OT-75, AEROSOL OT70-PG, AEROSOL OTS, AEROSOL TR70, AEROSOL GPG, AEROSOL AY, AEROSOL 1B, NEKAL WS25 and AEROSOL A196. These surface active agents are preferably used in the range of about 0.01 to about 10% by weight, particularly 0.1 to 3% by weight, based on the total aqueous biocide dispersion composition.

According to one embodiment of the present application, nonionic surfactants are employed such as polyoxyethylene (EO)/polyoxypropylene (PO) block copolymer (EO/PO block copolymer) for the preparation of phosphate-free aqueous biocide dispersion compositions and wherein the selected EO/PO block copolymers is a difunctional triblock copolymer preferably having the following generic structures I, II, III, IV or V:

HO(C₂H₄O)ₓ(C₃H₆O)_{y}(C₂H₄O)_{z}H (I)

HO(C₂H₄O)ₐ(C₃H₆O)_{b}(C₂H₄O)_{c}(C₃H₆O)_{d}(C₂H₄O)ₑH (II)

HO(C₃H₆O)ₓ(C₂H₄O)_{y}(C₃H₆O)_{z}H (III)

HO(C₃H₆O)ₐ(C₂H₄O)_{b}(C₃H₆O)_{c}(C₂H₄O)_{d}(C₃H₆O)ₑH (IV) or

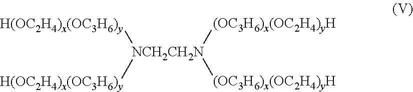

wherein x, y, z, a, b, c, d and e are integers between 1 to about 250. The value of such integers can be selected such that the molecular weight of the resulting copolymer is in the range of about 1000 to about 10,000.

The commercially available difunctional block copolymers would include but are not limited to PLURONIC P103, PLURONIC L 101, PLURONIC P65, PLURONIC-P108, PLURONIC-R25R2, PLURONIC-R31R1, WITCONOL-NS500LQ, PLURONIC-L31, PLURONIC-L35, PLURONIC-F127, PLURONIC-F108, PLURONIC-F88, PLURONIC-F87, PLURONIC-P85 and PLURONIC-L72.

The block copolymers of the present application preferably have a molecular weight of about 1000 to about 10000. Although the exemplary polyoxyethylene (EO)-polyoxypropylene (PO) block copolymer structures provided above have 3 or 5 blocks, it can include more or less than 3 and 5 blocks. Additionally, the block copolymer can also include additional repeating units such as butylene oxide repeating units. Moreover, the block copolymers that can be used according to the present application are characterized by their heteric polyoxyethylene-polyoxypropylene block copolymers.

Alternatively, the various other possible useful nonionic surfactants for preparing aqueous biocide dispersion compositions of the present application include, but are not limited to, polyoxyethylene alkyl ethers, polyoxyethylene alkylaryl ethers, polyoxyethylene alkylaryl ether/formaldehyde condensates, polyoxyalkylene aryl ethers, polyoxyalkylene alkyl esters, polyoxyalkylene alkyl sorbitol esters, polyoxyalkylene sorbitan esters, polyoxyalkylene alkyl glycerol esters, polyoxyalkylene block copolymer alkylglycerol esters, polyoxyalkylene alkyl sulfonamides, polyoxyalkylene rosin esters, polyoxypropylene block copolymers, polyoxyethylene oleyl ethers, polyoxyalkylene alkylphenols and mixtures consisting of two or more of these compounds.

Additional embodiment of the present application is to provide a uniform aqueous biocide dispersion composition system achieved by employing a suitable suspending/thickening agent. Suspending agents can help to suspend the components of the composition uniformly without modifying its original properties. For this purpose, various hydrocolloid gums employed would include, but are not limited to, xanthan gum, guar gum, gellan gum, locust bean gum, gum arabic, alginates, etc. and are used to impart thixotropic properties to the present compositions. In some embodiments, cellulose thickener is employed, which is a polysaccharide having anhydroglucose units further connected by an oxygen molecule to form a long molecular chains, having the ability to increase the density or viscosity of the dispersion in which it is integrated. Various cellulose thickeners employed in the present disclosure include, but are not limited to, hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxycthylmethyl cellulose, carboxymethyl cellulose, sodium carboxymethyl cellulose, microcrystalline cellulose, alone or in combinations thereof. Apart from this, hydrophilically modified ethoxylated urethane (HEUR), the hydrophobically modified ethoxylated urethane alkali swellable emulsions (HEURASE) are also optionally employed according to the requirement. Water-soluble gums are described in Encyclopedia of Polymer Science and Engineering, vol. 7, pp. 589-613 (John Wiley & Sons, Inc. N.Y., N.Y. 1987), the disclosure of which is incorporated by reference.

For example, the suitable commercial thickeners include, but are not limited to, Xanthan Gum®, (Kelzan® from Kelco), Rhodopol®23 (Rhone Poulenc) or Veegum® (from R.T.Vanderbilt), organic phyllosilicates (Attaclay® Engelhardt), HASE Thickener (RHEOLATE 425), ALCOGUM™ VEP-II (Alco Chemical Corporation), RHEO VIST™ and VISCALEX™ (Ciba Ceigy), UCAR®, ETHOCEL™ or METHOCEL™ (The Dow Chemical Company) and PARAGUM™ 241 (Para-Chem Southern, Inc.), or BERMACOL™ (Akzo Nobel) or AQUALON™ (Hercules) or ACUSOL® (Rohm and Haas). The hydrophobically modified ethoxylated urethane (HEUR) thickeners such as Acrysol RM 1020, Acrysol RM2020 and Acrysol RM5000 available from Rohm and Haas. Various other HEUR thickener would include Borchi Gel 0434, Borchi Gel 0435 and Borchi Gel 0011, Borchi Gel 0620, Borchi Gel 0621, Borchi Gel 0622, Borchi Gel 0625, Borchi Gel 0626, Borchi Gel PW 25, Borchi Gel LW44, Borchi Gel 0024, Borchi Gel WN50S, Borchi Gel L75N, Borchi Gel L76 from Borchers. Acrysol SCT-275, Acrysol RM8, Acrysol RM 825, Acrysol RM 895 (Rohm and Haas), Tafigel PUR 40, Tafigel PUR 41, Tafigel PUR 50, Tafigel PUR 60 Tafigel PUR 61 from Munzig, UCAR DR-73 from Robin and Haas, Acrysol TT615 available from Rohm and Haas, Aquaflow ALS 400 from Aqualon. The hydrophobically modified polyacetal polyether Aquaflow NLS 200, Aquaflow NLS 205, and Aquaflow NLS 210 available from Aqualon/Hercules.

The amount of thickener or suspending agent employed in the present high concentrated, phosphate-free aqueous biocide dispersion composition would generally fluctuate between about 0.1% to about 5.0% based on the total weight of the composition, more particularly from about 0.1% to about 3.0%. The quantity of thickener will generally be sufficient to impart a viscosity greater than 100 cp, for example from about 150 cp to about 14,000 cp.

Optionally, about 0.1 wt % to about 5.0 wt % of antifoaming or defoamers are employed to stop any unwanted foam generated while manufacturing highly concentrated aqueous biocide dispersion composition of the present application. The preferred antifoaming agent is selected from the group consisting of silicone based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. The commercially available antifoaming agents include, but are not limited to, defoamers that are available from DOW CORNING Dow Coming Corporate Center, Midland, Mich., U.S.A. which include: Antifoam FG-10 Emulsion; Antifoam H-10 Emulsion; Antifoam Y-30 Emulsion; 200® Fluid; 544 Antifoam Compound; FS-1265 Fluid; Antifoatn 1400 Compound Antifoam 1410 Emulsion; Antifoam 1430 Emulsion; Antifoam 1510-US Emulsion Antifoam 1520-US Emulsion; Antifoam 2200; Antifoam 2210; 7305 Antifoam; Q2-2617 Diesel Antifoam; Q2-2647 Diesel Antifoam; Q2-2677 Diesel Antifoam; Q2-2600 Diesel Antifoam; Antifoam A Compound; Antifoam AF Emulsion; Antifoam B Emulsion; .Antifoam C Emulsion; 2-3436 ANTIFOAM COMPOUND; 2-3522 ANTIFOAM COMPOUND; 2-3896 ANTIFOAM COMPOUND; 2-3898 ANTIFOAM COMPOUND; 2-3899 ANTIFOAM COMPOUND; 2-3900 ANTIFOAM COMPOUND; 2-3902 ANTIFOAM COMPOUND; 2-3911 ANTIFOAM; 2-3912 ANTIFOAM; 3160 ANTIFOAM COMPOUND; ANTIFOAM 1400; ANTIFOAM 1500; ANTIFOAM A COMPOUND; ANTIFOAM A COMPOUND-FOOD G RADE; Q2-4128 ANTIFOAM. The other suitable defoamers that are available from LUBRIZOL Corporation Wickliffe, Ohio include: Foam Blast® RKA and Foam Blast® RKB defoamers. Defoamers that are available from BYK-Chemie USA Inc. of 524 South Cherry Street, P.O. Box 5670, Wallingford, Conn., 064927651 Website: http://www.bvk-chemie.com include: BYK®-052; BYK®-057; BYK®-066 N; BYK®-088; BYK®-354; BYK®-392; BYK®-031; BYK®-032; BYK®-033; BYK®-034; BYK®-035; BYK®-036; BYK®-037; BYK®-038; BYK®-017; BYK®-018; BYK®-019; BYK®-020; BYK®-021; BYK®-022; BYK®-023; BYK®-024; BYK®-025; BYK®-028 A; BYK®-044; BYK®-045; BYK®-060 N; BYK®-065; BYK®-066 N; BYK®-067 A; BYK®-070; BYK®-071; BYK®-080 A; BYK®-088; BYK®-094; BYK®-141; BYK®-1610; BYK®-1615; BYK®-1650; BYK®-1660; Byketol®-WS; BYK®-011; BYK®-012; BYK®-051 BYK®-052; BYK®-053; BYK®055; BYK®-057; BYK®-A 500; BYK®-A 501; and BYK®-A 530 defoamers, Suitable defoamers include those available from Tego Chemie Service GmbH a business unit of the Degussa AG, Tego Chemie Service GmbH, Goldsclunidtstr. 100, 45127 Essen, Germany; Degussa Tego Coating and Ink Additives, 1111 South 6th Avenue, P.O. Box 1111, Hopewell, Va. 23838, USA include: TEGO® Foamex 3062, TEGO® Foamex 8050, TEGO® Foamex K 3, TEGO® Foamex 1488, TEGO® Foamex 7447, TEGO® Foamex 800, TEGO® Foamex 805, TEGO® Foamex 808, TEGO® Foamex 815, TEGO® Foamex 822, TEGO® Foamex 825, TECO® Foamex 845, TEGO® Foamex 1495, TEGO® Foamex 8030, TEGO®Foamex 810, TEGO® Foamex 830, TEGO® Foamex 832, TEGO® Foamex 835, TEGO® Foamex 840, and TEGO® Foamex 842 defoamers. Defoamers that are suitable include those available from Momentive Performance Chemicals, 22 Corporate Woods Boulevard, Albany, N.Y. 12211 USA include SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

In accordance with one preferred embodiment of the present application, there is provided a process for preparing a stable, flowable and phosphate-free highly concentrated aqueous dispersion composition of a biocide comprising the steps of: (i) preparing a homogenous mixture of at least one biocide, sulfosuccinate surfactant, block copolymer, suspending agent and additives if any by thoroughly mixing them for at least 15 minutes; (ii) grinding the resultant homogenous mixture (i) with a grinding aid such as zirconium dioxide beads until it results in a Hegmann number of about 6 to 7; and (iii) optionally, adding an antifoaming agent.

The homogenous mixture of components of the aqueous dispersion composition is prepared by suitable methods that are known to a person who is skilled in the art. The known comminution methods include, but are not limited to, triturating, grinding and/or milling in order to achieve the resultant homogenous mixture having a particle size of less than about 0.5 μm to about 10.0 μm and preferably about 0.5 μm to about 3.0 μm. Particle size reduction is carried out preferably in mills, for example, basket mills, ball mills, agitator ball mills, circulating mills (agitator ball mills with pin grinding system), disk mills, annular chamber mills, double cone mills, triple roll mills and batch mills. To dissipate the heat energy introduced during the grinding process, the grinding chambers are preferably fitted with cooling systems.

The grinding or milling media for the preparation of homogenous mixture of biocide dispersion composition is selected from the group consisting of steel shots, carbon steel shots, stannous steel shots, chrome steel shots, tungsten carbide, silicon nitride, silicon, carbide, ceramic, zirconium based media including zirconia, zirconium silicate, zirconium oxide, stabilized zirconia such as yttrium stabilized zirconia, calcium stabilized zircona, magnesium stabilized zirconia, cerium stabilized zirconia, stabilized magnesium oxide, stabilized aluminum oxide and the like. A preferred grinding media of the present application is zirconium based.

In order to prepare the aqueous dispersion composition of biocides, the aqueous medium can be any type of water known in the art for this purpose and preferably selected from distilled water, de-ionized water, double distilled water, triple distilled water, tap water, de-mineralized water, reverse-osmosis water, alone or in combinations thereof.

In another embodiment of the present application, the aqueous biocide dispersion composition is stable for at least two years at room temperature or stable for at least about 5 freeze/thaw cycles wherein temperature is cycled from 50° C. to −24° C. in every 24 hours, or stable for at least 4 weeks at about 50° C.

The dispersion composition of the present application is easily flowable by its own gravity, by conventional mechanical means or through any pneumatic pump that is known in the art.

Further, the aqueous dispersion compositions of the present application do not dry up on storage or on transit for at least 18 months at room temperature.

The high concentrated dispersion composition is further diluted to about 0.5 wt % to about 10.0 wt %. This diluted solution does not show up any settling issues and it remains stable for at least one week.

Various other compounds or additives can be added to the present aqueous dispersion compositions to enhance or obtain desired properties. The additives include, but are not limited to, plasticizers, surfactants, wetting agents, fillers, coloring agents, dispersing agents, thickening agents, thixotropic agents, antifreezing agents, co-solvent, pH adjusting agents, scale inhibitors, corrosion inhibitors, ultraviolet light stabilizers, antioxidants, algaecide, preservative, antimicrobial agents and the like. Additional components optionally included in the composition can be for example additional polymeric materials, fragrances, colorants, buffers, hydrotropes, anti-soil agents and enzymes.

The dispersing agents can be selected from standard organic polymeric dispersants that are known in the art for preparing highly concentrated aqueous biocide dispersion compositions and suitable dispersing agent would be readily available to a person skilled in the art from the prior art. However, preferred dispersing agents include poly(methylvinyl ether-co-maleic acid) partially neutralized with sodium hydroxide (EasySperse, EaseySperse P20 by ISP, Wayne N.J.) and polymers of acrylic and methacrylic acid, C11-C15 secondary ethoxylated alcohols and diols, PEG-PLGA-PEG copolymers and polyether polyols. Additional examples of suitable dispersants include sodium silicate, sodium carbonate, lignosuiphonic acid salts (e.g., Polyfon, Ufoxane or Marsperse), a sulfonated naphthalene/formaldehyde condensate (e.g., Morwet), a block copolymer with pigment affinic group (e.g., Disperbyck 190), 1,4 bis(2-ethylhexyl)sodium-sulfosuccinate (e.g., Triton GR PG 70), Polyether-polycarbonate sodium salt (e.g., Ethacryl P), maleic acid-olefin co-polymer (e.g., Vultamol NN 4501), ammonium polyacrylate (e.g., Dispex GA 40), C6-C 15 secondary alcohol and alkyl aryl sulfonate (e.g., Zetasperse 2300) and alkyl naphthalene sulfonate (e.g., Agnique), henolsulphonic or naphthalenesulphonic acid salts, 2-amino-2-methyl-1-propanol, tri and tetra sodium salts of pyrophosphate and polyphosphate and water-soluble sodium or ammonium salts of polyacrylates, polycarboxylates and polymethacrylates.

According to another preferred embodiment of the present application, surface active or wetting agents from acetylene glycol based compounds and/or an acetylene alcohol surface active agent are employed to reduce the surface tension along with block copolymers and sulfosuceinate surfactants. Particularly preferred acetylene glycol group of compounds are 2,4,7,9-tetramethyl-5-decyne-4,7-diol, 3,6-dimethyl-4-octyne-3,6-diol, and 3,5-dimethyl-1-hexyn-3-ol. The commercially available acetylene glycol surface active agents would include but are not limited to Surfynol series 61, 104, 82, 440, 465, 485, TG and CT-111 CT-121, CT-131, CT211 produced by Air Products and Chemicals, Inc., and Olfine series STG and E1010, supplied by Nisshin Chemical Industry Co., Ltd. These surface active agents are preferably used in amounts of 0.01 to 10% by weight, particularly 0.1 to 2% by weight, based on the total aqueous dispersion composition.

According to one important embodiment of the present application, the pH of the aqueous dispersion compositions is in the range of about 3.0 to about 8.0. The desired pH of the composition can be obtained by employing any suitable inorganic bases such as sodium hydroxide, ammonium hydroxide and potassium hydroxide, or amines such as triethanol amine, diethanol amine or monoethanol amine. The acidic agents employed to adjust the pH of the composition include, but are not limited to, hydrochloric acid, acetic acid, salicylic acid, citric acid, sulfamic acid alone or in combination. Some non-limiting examples of suitable buffers include phosphates, pyrophosphate and its salts, metaphosphate and its salts, carbonic acid and its salts, hydroxylammonium, adidic acid and its salts, maleic acid and its salts, and ascorbic acid and its salts.

A suitable inert carrier is optionally employed in the preparation of highly concentrated aqueous biocide dispersion composition of the present application to have enhanced flowing ability. The preferred inert carrier is selected from the group consisting of finely ground natural minerals, ground synthetic minerals and/or metal oxides including titanium dioxide and preferably selected from the group consisting of clays, talc, chalk, quartz, attapulgite, montmorillonite or diatomaceous earth, perlite or “expanded perlite”, zeolite including microphorous aluminosilicate, highly-disperse silica, alumina, mica, wollastonite, silicate or aluminosilicate. Clay minerals of kandite group, for example kaolinite, dickite, nacrite and halloysite, have been found to be particularly advantageous. “Kaolinite” includes kaolin type clays, ball clays, fire clays and China clays. Such clays occur in nature in the form of kaolinite plus other minerals, e.g., illite, mica, quartz and feldspar. The preferred silicates are oxidized silicon compounds such as SiO₃, SiO₄, Si₂O₆ and Si₂O₇. The most preferred inert carrier material would include but are not limited to Huber 80, Huber 90, Polygloss 80, Polygloss 90, Dixieclay®, Par® and Bilt-Plates® 156 and titanium dioxide.

Further, it is desired to employ significantly lesser quantity of one or more VOC-free solvents as co-solvent for the preparation of aqueous biocide dispersion composition. These solvents are selected from the group consisting of, but are not limited to, glycols, polyglycols, ethers of glycol, esters of glycol, cyclic diols, non-cyclic diols, glycerols, ethers or esters of glycerol, mixture of glycerols and/or mixture of polyglycerols. The preferred glycols of the application are ethylene glycol, 1,2-propylene glycol, 1,3-propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 3-methyl-1,5-pentanediol, 2,3-dimethyl-2,3-butanediol, 2,4-dimethyl-2-ethyl-hexane-1,3-diol, 2,2-dimethyl-1,3-propanediol, 2-ethyl-2-butyl-1,3-propanediol, 2-ethyl-2-isobutyl-1,3-propanediol, 1,2-butanediol, 1,3-butanediol, 1,4-butanediol, 1,4-pentanediol, 1,5-pentanediol, 1,6-hexanediol, 2,2,4-tetra methyl-1,6-hexanediol, thiodiethanol, 1,2-cyclohexanedimethan-ol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol and/or hydrogenated bisphenol-A.

Optionally, amine based wetting agents are employed for the preparation of aqueous biocide dispersion compositions. The suitable amine based wetting agents for the present application is selected from the following non-limiting group of compounds: primary amines, secondary amines, tertiary amines, quaternary amines, alkanolamines, mono-alkyl alkanolamines, di-alkyl alkanolamines, tri-alkyl alkanolamines, alkyl mono alkanolamines, alkyl di-alkanolamines, alkylamines, mono-alkyl amines, di-alkyl amities, tri-alkylamines, alkoxylated amines, methoxylated alkylamines, ethoxylated alkylamines, alkoxylated alkanolamines, alkyl alkanolamines, amido amines and/or fatty amines. The preferred wetting agents of the present application would include, but are not limited to, amido amities and fatty amines such as amodimethicone, stearamido propyl dimethyl amine, stearamidopropyl dimethylamine citrate, lauramidopropyl dimethylamine, palmitamidopropyl diethylamine, cocamidopropyl dimethylamine lactate, myristamidopropyl dimethyl amine. A variety of commercially available amido amines would include but are not limited to MIRISTOCOR® from Hoffman-La Roche Inc., Nutley, N.J. (USA); Schercodine® M from Scher Chemicals Inc., Clifton, N.J. (USA); LEXAMINE® L-13 from Inolex Chemical Company, Philadelphia, Pa. (USA); LEXAMINE® S-13 from Inolex Chemical Company and fatty amines from PG chemical under the trade names of AT-1095, AT-1295, AT-1495, AT-1695A, AT-1895A, AT-1270, AT-121416, AT-1214, AT-1026 and/or AT-1822A 1822A.

The dispersion composition can also be formulated in other suitable deliverable forms according to need such as suspension, solution, diluted solution, microemulsion, nano emulsion and/or nano-particle dispersion and the like.

The aqueous dispersion composition prepared according to the present application is suitable for protecting industrial materials and wherein the industrial materials in the present context are non-living materials which have been prepared for use in industry. Aqueous dispersion of the present application is employed in the following non-limiting fields such as paint, building materials, stucco, concrete, caulks, sealants, joint compounds, adhesives, paper, card, textiles, coating materials and plastic articles, cooling lubricants, cooling water circulations, leather, wood, inks, pigment dispersions, agricultural applications, seed coatings, pesticide compositions, metal working fluids, aqueous hydraulic fluids, drilling mud, and/or clay slurries those may be attacked or decomposed by microorganisms.

Further, the present application is illustrated in detail by way of the below given examples. The examples are given herein for illustration of the invention and are not intended to be limiting thereof.

### EXAMPLE 1

| Ingredient | Weight % |
|---|---|
| Water | 41.27 |
| BIT (84.0%) | 53.40 |
| Wetting agent | 0.50 |
| Xanthan gum | 0.20 |
| Alkyl/dialkyl sulfosuccinate | 1.20 |
| Pluronic P 103 | 0.55 |
| Pluronic L 101 | 0.35 |
| Kaolin | 1.25 |
| Antifoam 1430 | 0.08 |
| NaOH (50%) | 1.20 |

A freeze thaw and high temperature (50 C for 1 month) stable product that is greener and do not dry up on storage is obtained. The Hegmann grind is 7 and viscosity range from 2000-3000 CP. The pH of the product is 7.8.

### EXAMPLE 2

| Ingredient | Weight % |
|---|---|
| Water | 41.27 |
| BIT (84.0%) | 53.40 |
| Surfynol CT 111 | 0.50 |
| Xanthan gum | 0.20 |
| Dihexyl sulfosuccinate | 1.20 |
| Pluronic P 103 | 0.55 |
| Pluronic L 101 | 0.35 |
| Kaolin | 1.25 |
| Antifoam 1430 | 0.08 |
| NaOH (50%) | 1.20 |

A product with viscosity around 3500-4500 is obtained. The product is low foaming and stable on 100 fold dilution for few days.

### EXAMPLE 3

| Ingredient | Weight % |
|---|---|
| Water | 42.90 |
| BIT (84.0%) | 53.80 |
| Citric acid | 0.50 |
| PEG 400 | 0.50 |
| Na/K salt of Alkyl/dialkyl | 1.5 |
| sulfosuccinate | |
| Pluronic P 103 | 0.5 |
| Xanthan gum | 0.1 |
| Antifoam 1430 | 0.2 |

A highly stable flowable dispersion with a viscosity range between 2000-3000 CP is obtained. The pH of the sample is around 5.2.

### EXAMPLE 4

| Ingredient | Weight % |
|---|---|
| Water | 46.4 |
| MIT | 25.0 |
| CMIT | 8.0 |
| Bronopol | 15.0 |
| Kaolin | 1.5 |
| Fatty Amine (AT1026) | 2.0 |
| Citric acid | 0.5 |
| Dioctyl sulfosuccinate | 1.0 |
| Plutonic P103 | 0.5 |
| Xanthan gum | 0.1 |

A stable dispersion at around pH 3.0 is obtained.

### EXAMPLE 5

| Ingredient | Weight % |
|---|---|
| Water | 43.5 |
| BIT | 30.0 |
| OIT | 20.0 |
| Myrstamidopropyl dimethyl amine | 2.0 |
| Kaolin | 2.0 |
| Ethylhexyl sulfosuccinate | 0.8 |
| Pluronic L101 | 0.4 |
| Pluronic L 64 | 0.6 |
| Antifoam 1430 | 0.1 |
| Xanthan gum | 0.1 |
| NaOH | 0.5 |

A stable dispersion with viscosity around 2500-3500 CP and pH 7.4 is obtained.

### EXAMPLE 6

| Ingredient | Weight % |
|---|---|
| Water | 46.4 |
| BIT | 45.0 |
| ZnPy | 5.0 |
| Pluronic P 103 | 0.6 |
| Easysperse P 20 | 0.3 |
| dioctyl sulfosuccinate | 0.6 |
| Xanthan gum | 0.1 |
| Kaolin | 2.0 |

A stable dispersion around pH 6.4 is obtained. The viscosity is around 3500-4500 CP.

### EXAMPLE 7

| Ingredient | Weight % |
|---|---|
| Water | 44.0 |
| BIT | 36.0 |
| MIT | 12.0 |
| Pluronic L 101 | 0.5 |
| Pluronic P 103 | 0.7 |
| Ethyl hexyl sulfosuccinate | 1.2 |
| Kaolin | 2.0 |
| Xanthan gum | 0.1 |
| Sag 30 | 0.1 |

A Stable dispersion around pH 6.2 is obtained the viscosity is around 3000-4000 CP

### EXAMPLE 8

| Ingredient | Weight % |
|---|---|
| Water | 45.3 |
| BIT | 30.0 |
| IPBC | 20.0 |
| Pluronic L 101 | 0.6 |
| Pluronic P 103 | 0.8 |
| Ethylhexyl sulfosuccinate | 0.8 |
| Easysperse P 20 | 0.3 |
| Kaolin | 1.5 |
| Titanium dioxide | 0.5 |
| Xanthan gum | 0.2 |

A stable dispersion with a pH around 6.1 is obtained. Viscosity is around 3880-4000 CP

### EXAMPLE 9

The efficacy of the formulation described in Example 1 was evaluated in a latex resin and in a joint compound. The microbiological evaluations shown as examples are based on ASTM D2574-94, “Resistance of emulsion paints in the container to the attack of microorganisms”. The resin latex and the joint compound were prepared to contain different concentrations of formulation described in Example 1. Each sample thus prepared was then inoculated with a mixed culture containing Pseudomonas aeruginosa (ATCC 10145), Enterobacter cloacae (ATCC 13047), Bacillus subtilis (ATCC 27348), Bacillus licheniformis (ATCC 27326), and Bacillus megaterium (ATCC 27327) (final concentration of about 10⁶ CFU/ml) and re-challenged after 7 days (final concentration of about 10⁷ CFU/ml). Samples were incubated at 32° C. for the duration of the test and sampled for the presence of viable bacteria on TSA plates. Growth was rated on a scale from “0” no growth) to “4” (heavy growth). A sample was considered appropriately preserved if no bacterial (“0” rating) growth was detected after six days in both challenge assays. The Table 1 summarizes the results obtained for the efficacy of formulation described in Example 1, and was demonstrated at 110 ppm and 150 ppm depending on the product tested.

TABLE 1

| | | Challenge 1 | | | | Challenge 2 | | | |
|---|---|---|---|---|---|---|---|---|---|
| Sample | ppm | 1 | 2 | 3 | 6 | 1 | 2 | 3 | 6 |
| Latex resin | | | | | | | | | |
| Control | | 2 | 2 | 2 | 2 | 4 | 4 | 4 | 4 |
| +Example 1 | 40 | 1 | 1 | 0 | 0 | 0 | 0 | 0 | 0 |
| +Example 1 | 110 | 0 | 0 | 0 | 0 | 0 | 0 | 0 | 0 |
| Joint Compound | | | | | | | | | |
| Control | | 4 | 4 | 4 | 4 | 4 | 4 | 4 | 4 |
| +Example 1 | 55 | 1 | 1 | 1 | 1 | 3 | 3 | 2 | 2 |
| +Example 1 | 150 | 0 | 0 | 0 | 0 | 1 | 2 | 2 | 0 |

While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those skilled in the art without departing from the scope and spirit of this invention.

We claim:

1. A stable, flowable and phosphate-free highly concentrated aqueous dispersion composition comprising:
i. about 20.0 wt % to about 60.0 wt % of at least one biocide;
ii. about 0.1 wt % to about 10.0 wt % of at least one sulfosuccinate surfactant;
iii. about 0.1 wt % to about 5.0 wt % of block copolymer surfactant;
iv. about 0.1 wt % to about 5.0 wt % of suspending agent;
v. optionally, about 0.1 wt % to about 5.0 wt % of antifoaming agent; and
vi. optionally, at least one additive.

2. The dispersion composition according to claim 1, wherein said biocide is selected from the group consisting of 2-methyl-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (OIT) 3-iodo-2-propynylbutyl carbamate (IPBC), oxyfluorfen, thiabendazole, terbutryn, zinc pyrithione (ZnPy), bronopol, folpet, diruon, dehydroacetic acid (DHA), dazomet, carbendazim alone or in combination.

3. The dispersion composition according to claim 1, wherein said sulfosuccinate is selected from the group consisting of sulfosuccinate monoester, sulfosuccinate diester, monoalkyl sulfosuccinate, dialkyl sulfosuccinate or their alkali metal salts.

4. The dispersion composition according to claim 1, wherein said sulfosuccinate is selected from the group consisting of lauryl sulfosuccinate, laureth sulfosuccinate, laureth-5 sulfosuccinate, ricinoleamide MEA sulfosuccinate, undecyleneamide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts alone or in combination.

5. The dispersion composition according to claim 1, wherein said block copolymer is selected from the group consisting of difunctional block copolymers or triblock copolymers of polyethyleneoxide (PEO) and polypropyleneoxide (PPO).

6. The dispersion composition according to claim 1, wherein the polyethyleneoxide (PEO) and polypropyleneoxide (PPO) block copolymer has an average molecular weight hydrophobe portion of from about 1000 to about 10000.

7. The dispersion composition according to claim 1, wherein the viscosity is in the range of about 100 to about 14,000 centipoises (CP).

8. The dispersion composition according to claim 1 is neutral or acidic, and wherein pH is in the range of about 3 to about 8.

9. The dispersion composition according to claim 1, wherein the composition is stable for at least 18 months at room temperature or stable for at least 5 freeze-thaw cycles, and wherein the temperature is cycled from 50° C. to −24° C. in every 24 hours or stable for at least 4 weeks at about 50° C.

10. The dispersion composition according to claim 1, wherein the composition is easily flowable and do not dry-up on storage of at least 18 months at room temperature.

11. The dispersion composition according to claim 1, wherein the concentrate is further diluted to about 0.5 wt % to about 10.0 wt % and remains stable for one week.

13. The dispersion composition according to claim 1, wherein said additive is selected from the group consisting of wetting agents, suspending agents, thickening agents, emulsifying agents, antifoaming agents, dispersing agents, inert carriers, metal oxides, preservatives, pH modifiers, amines alone or in combination.

14. The dispersion composition according to claim 13, wherein said wetting agent is selected from the group consisting of alkoxylated acetylenic dials and/or 2,4,7,9-tetramethyl-5-decyne-4,7-diol.

15. The dispersion composition according to claim 13, wherein said dispersing agent is selected from the group consisting of copolymer of 2-pyrrolidone and methoxy ethylene sodium salt, polymers of acrylic and methacrylic acids, C₁₁-C₁₅ secondary ethoxylated alcohol, diols sodium silicate, sodium carbonate, lignosulphonic acid salts, C₆-C₁₅ secondary alcohol and alkyl aryl sulfonate and/or polyether polyols or poly (methylvinyl ether-co-maleic acid) partially neutralized with sodium hydroxide.

16. The dispersion composition according to claim 13, wherein said pH modifying agent is selected from the group consisting of alkali metal hydroxides, amines, inorganic acids, hydrochloric acid, acetic acid, salicylic acid, citric acid, sulfamic acid alone or in combination.

17. The dispersion composition according to claim 13, wherein said inert carrier is selected from the group consisting of ground natural minerals, ground synthetic minerals, metal oxides and preferably selected from the group consisting of clays, kaolin clay, talc, chalk, quartz, attapulgite, montmorillonite or diatomaceous earth, perlite, zeolite, highly-disperse silica, alumina, titanium dioxide and silicates alone or in combination thereof.

18. The dispersion composition according to claim 13, wherein said antifoaming agent is selected from a group consisting of silicone based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination.

19. The dispersion composition according to claim 13, wherein said amine is amidoamines or fatty acid amines alone or in combination.

20. The dispersion composition according to claim 1 formulated as an emulsion, solution and/or suspension.

21. The dispersion composition according to claim 1 employed in the field of paint, building materials, stucco, concrete, caulks, sealants, joint compounds, adhesives, leather, wood, inks, pigment dispersions, metal working fluids, drilling mud, clay slurries, agricultural applications, seed coatings and/or pesticide compositions.

22. A process for preparing a stable, flowable and phosphate-free highly concentrated aqueous dispersion composition comprising the steps of:
i. preparing a homogenous mixture of at least one biocide, sulfosuccinate surfactant, block copolymer, suspending agent, and additives if any by thoroughly mixing for at least 15 minutes;
ii. grinding the resultant homogenous mixture of (i) with zirconium dioxide beads until it results in Hegmann number of about 6 to 7; and
iii. optionally, adding an antifoaming agent.
